(19) United States
(12) Patent Application Publication
(10) Pub. No.: US 2002/0052896 A1
(43) Pub. Date: May 2, 2002

(54) Secure signature and date placement system

(76) Inventors: Jason Mitchell Streit, Austin, TX (US); Marion R. Rice, Rochelle, TX (US); Bindu R. Rao, Austin, TX (US)

Correspondence Address: Bindu R. Rao, 3414 Rosefinch Trail, Austin, TX, 78746, US

(21) Appl. No.: 09/824,529

(22) Filed: Apr. 2, 2001

Related U.S. Application Data
(60) Provisional application No. 60/206,851, filed on May 23, 2000.
(60) Provisional application No. 60/236,128, filed on Sep. 28, 2000.
(60) Provisional application No. 60/235,228, filed on Sep. 25, 2000.

(51) Int. Cl. G06F 15/00

(52) U.S. Cl. 707/517

(57) ABSTRACT

An Internet-based drag and drop signature and date placement system is used by users such as lawyers, doctors, patients, nurses, home health care agencies, hospitals, etc. to gets documents signed after creators of the documents specify the signature and date locations and save them with or in the documents that need to be signed. The servers that store and provide documents employ digital certificates and other security mechanisms to make the retrieval of documents secure. Users therefore need digital certificates to retrieve documents from a secure document server before being able to sign them. A signer needs to have his signature captured once as ad electronic image signature so as to be able to use them for signing purposes subsequently. The creator of a document employs a document viewer on his computer or browser to drag and drop signature and/or date locations on his documents. The signature and date locations thus specified are saved, over the Internet, along with the document, and are subsequently used for placing electronic image signatures of signers when they sign the document, and for inserting dates as appropriate. More than one signers may be required to sign a document, and the order in which they must sign can be specified.

### CROSS REFERENCE TO RELATED APPLICATIONS

This application is based on U.S. Provisional Application Ser. Nos. 60/235,128 and 601206,851, both filed Sep. 28, 2000, and on Application Ser. No. 60/235,228 filed on May 23, 2000. Such Provisional Applications are hereby incorporated herein by reference in their entirety.

### BACKGROUND

1. Technical Field

The present invention relates generally to signing documents, and more specifically to the specification of coordinates for electronic image signatures and dates on documents and the subsequent placement of signatures and associated dates into documents.

2. Related Art

Documents in general, and financial documents and legal documents in particular, are signed by one or more individuals. The signatures are sometimes necessary for legal purposes, and the dates when these signatures were acquired are also typically important, For example, a physician's signature is essential for processing patient care related information in hospitals and in home health care agencies, and are often required before disbursement of funds.

With the rapid acceptance of the Internet by businesses, much of the work that businesses conduct is likely to move to the Internet. The Internet makes it easy to transfer information, interact remotely and to exchange files. However, the need to sign and approve documents as part of normal business transactions has not gone away.

### BRIEF DESCRIPTION OF THE DIAGRAMS

The numerous objects and advantages of the present invention may be better understood by those skilled in the art by reference to the accompanying figures in which:

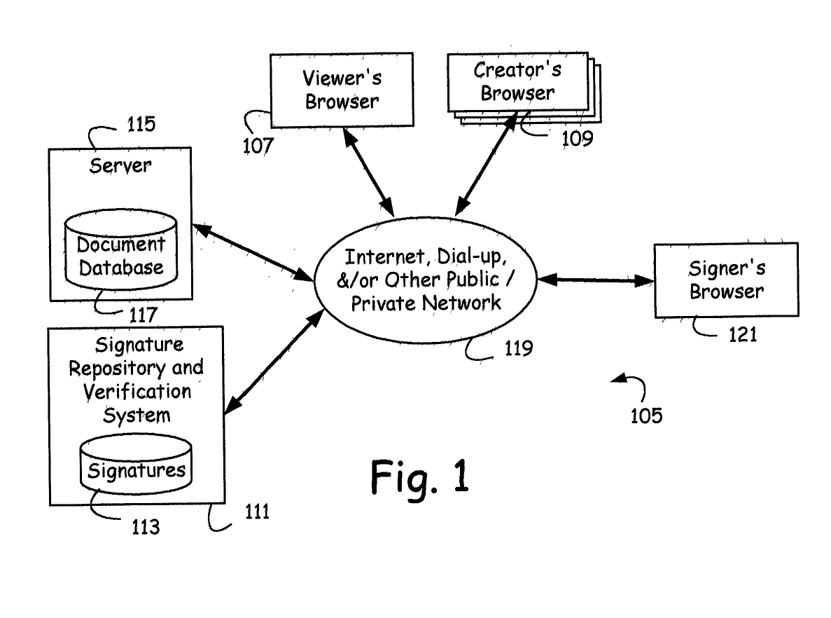

FIG. 1 is a perspective diagram of an secure signature and date placement system (also called a document flow network) that provides mechanisms for the specification of coordinates, for signatures and dates, on documents and for the subsequent placement of signatures and dates in the specified coordinates;

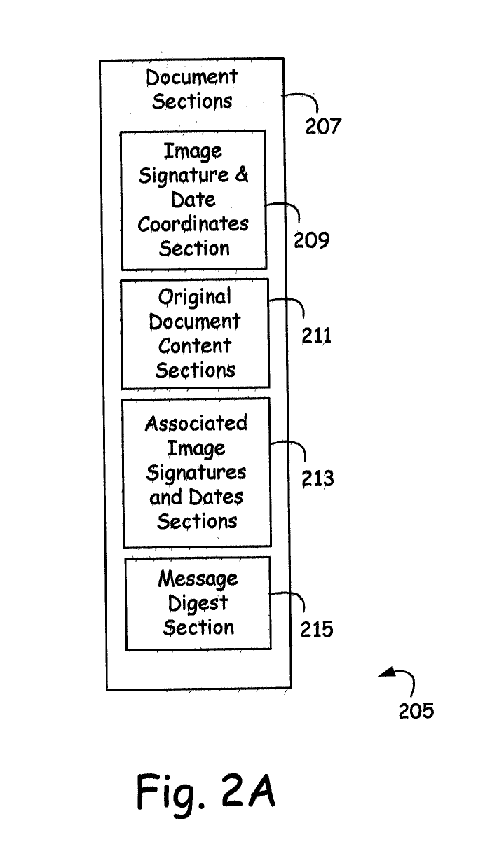

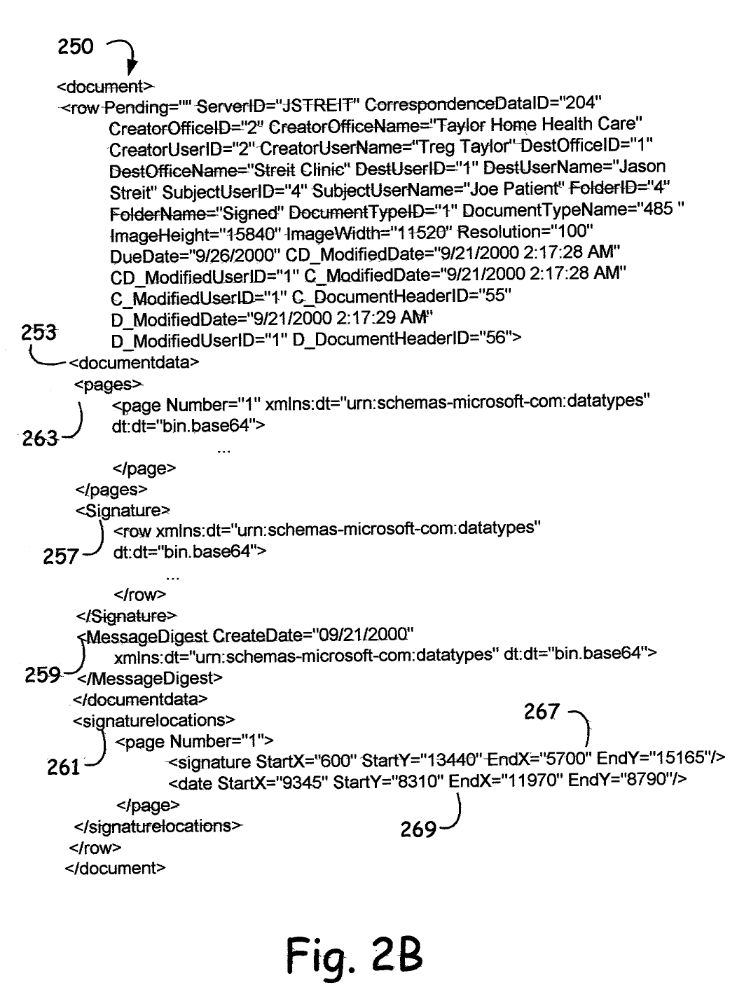

FIG. 2A is a block diagram of an exemplary document that, while being made secure employing a user's public and private key combination, also has embedded electronic image signatures and associated dates along with information regarding the placement of such electronic image signatures and dates;

FIG. 2B is an exemplary document in an extensible manipulation language (XML) format that comprises a documentdata element for the specification of document content, signature content and message digest content, and a signaturelocations element for specification of signatures and date placements

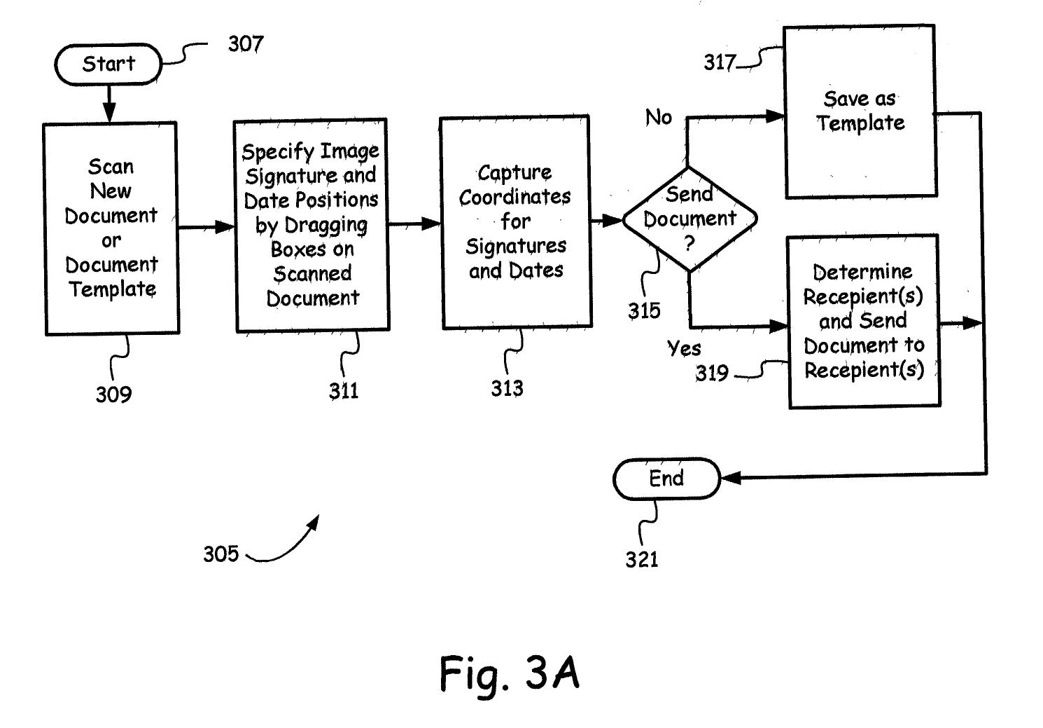

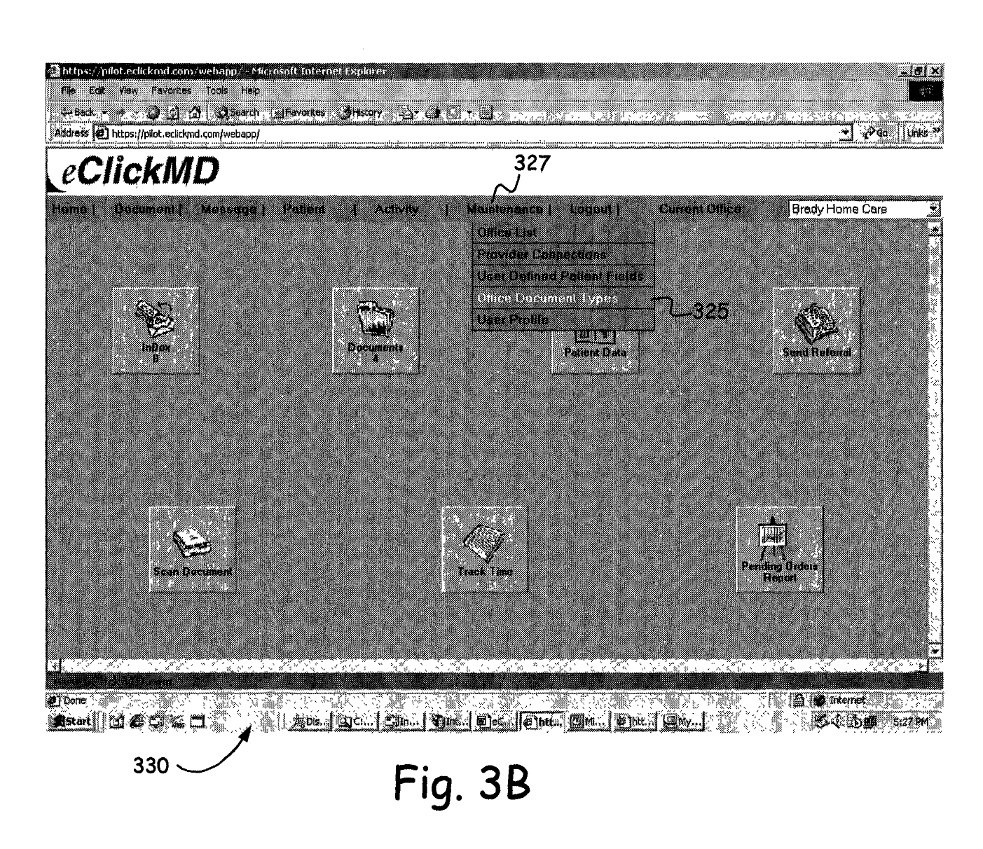

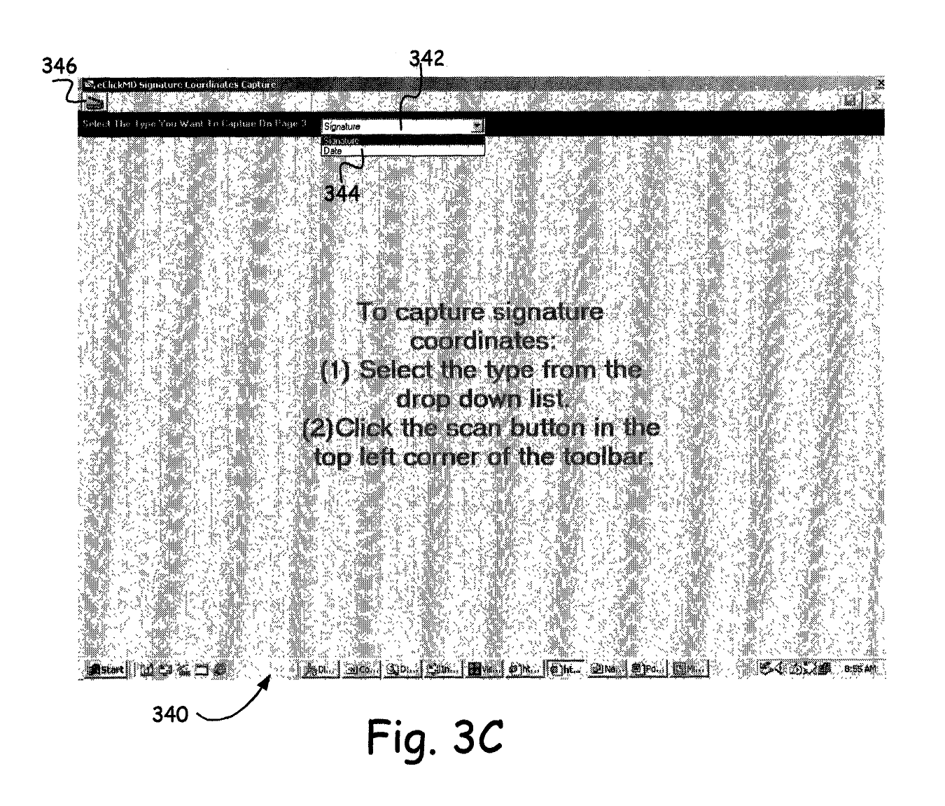

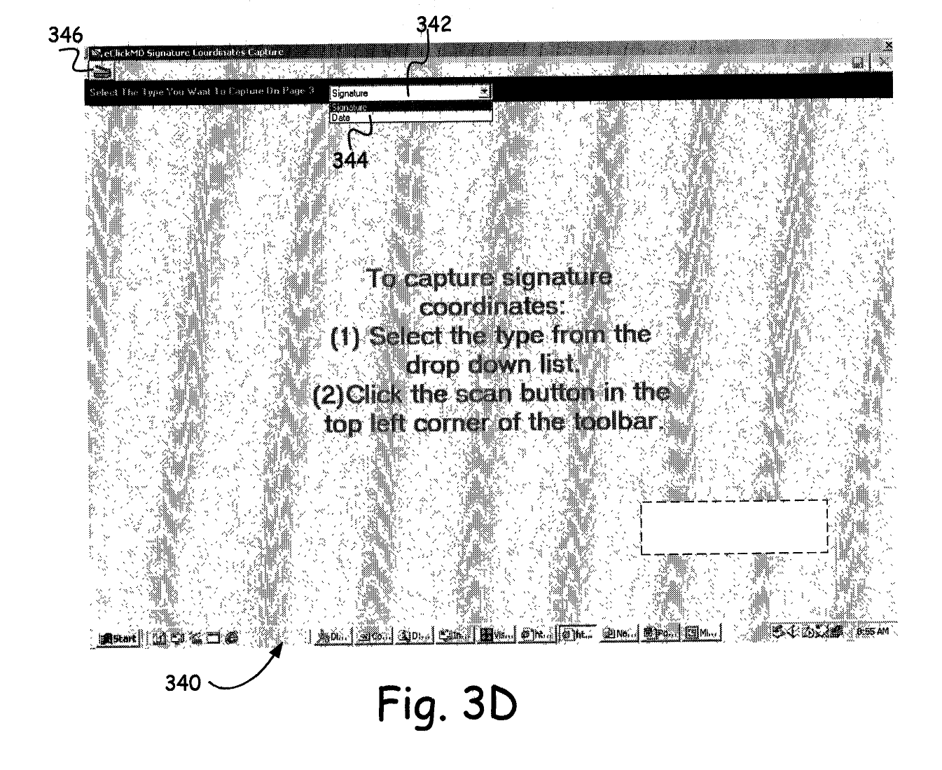

FIG. 3A is a schematic block diagram depicting the process of capturing signature and date placement information on a given document that has been scanned in, using the creator's browser or a document viewer software application;

FIG. 3B is a diagram with a screen shot of an exemplary application wherein a new office document type is defined and signature coordinates and date coordinates are subsequently specified using an Internet-based application;

FIG. 3C is a diagram with a screen shot of the exemplary Internet-based application showing the process of capturing signature and date coordinates after scanning in a document template using a scanner;

FIG. 3D is a diagram with a screen shot of the exemplary application showing the process of specifying signature or date coordinates by dragging a box using a mouse on the image of a scanned document;

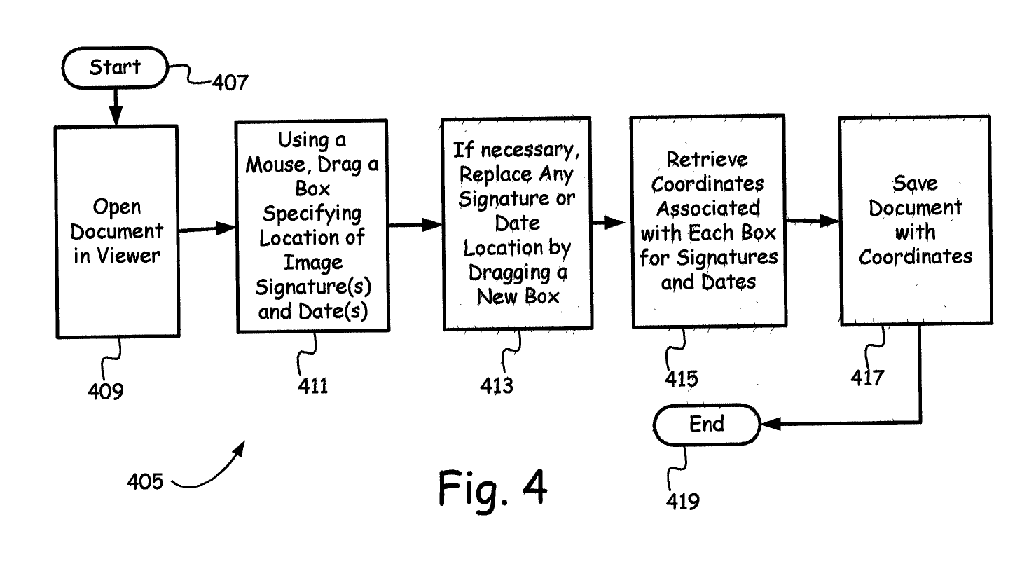

FIG. 4 is a schematic block diagram describing the process of specifying signature placement information by dragging a mouse on a document; and

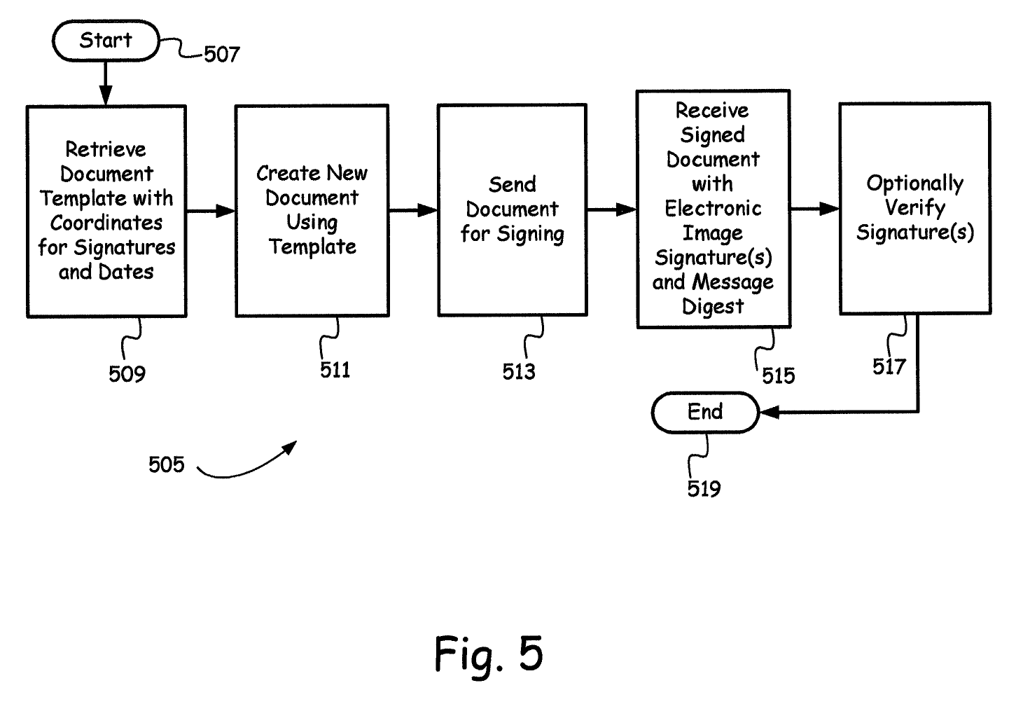

FIG. 5 is a schematic block diagram showing the workflow associated with the signing of documents using electronic image signatures.

### SUMMARY OF THE INVENTION

An information item placement system comprises a document, a plurality of information items and a location specification component. The location specification component facilitates the selective specification of placement information for the plurality of information items within the document.

In one embodiment, the information item placement system the plurality of information items selectively comprises signatures, images, dates, images, text and/or logos. In a related embodiment, the selectively specified placement information for the plurality of information items within the document is saved as part of the document. In another related embodiment, the selectively specified placement information for the plurality of information items within the document is saved separately from the document. In a different embodiment, the location specification component is a document viewer software that displays the document and provides location specification means. In a related embodiment, the location specification means comprises a drag-and-drop box drawing utility with optional box relocation features, wherein the drag-and-drop box drawing utility captures the page number and the x- and y-coordinates of a rectangular box drawn within a page to specify the placement of one of the plurality of information items in the document.

In another related embodiment, the placement information for the one of the plurality of information items in the document is selectively replaced by redrawing the rectangular box to specify a new location of the one of the plurality of information items in the document.

In another different embodiment, the placement information for each of the plurality of information items is expressed in terms of a page number of an associated page where it occurs in the document and the x- and y-coordinates of its location within the associated page.

In one embodiment the plurality of information items comprises one or more signatures and dates and the document comprises a plurality of original document content sections. Some exemplary sections are image signature and date coordinates section for saving the placement information of one or more signatures and dates; an associated image signatures and dates sections for saving one or more signatures and dates; and a message digest section that is used to store a message digest that is computed selectively employing the contents of one or more of the other sections of the document.

In a related embodiment, the plurality of original document content sections comprises a plurality of sections of a document are originally created using a document editor. In a scanner based information item placement system the plurality of original document content sections comprises a plurality of scanned sections of a document.

In one embodiment, the location specification means comprises a drag-and-drop box drawing utility with optional box relocation features. The drag-and-drop box drawing utility facilitates the selective specification of placement information for the plurality of information items within the document. The drag-and-drop box drawing utility also captures the page number and the x- and y-coordinates of a rectangular box drawn within a page to specify the placement of one of the plurality of information items in the document. The placement information for each of the plurality of information items expressed in terms of a page number of an associated page where it occurs in the document and a pair of x- and y-coordinates corresponding to a rectangular box drawn on the associated page specifying its location within the associated page.

In a related embodiment, the placement information for each of the plurality of information items is selectively replaced by redrawing the rectangular box drawn on the associated page or by adjusting the value of the associated pair of x- and y-coordinates.

In a different embodiment, the information item placement system comprises an Internet browser that is used to retrieve a document, a plurality of information items that is selectively placed in the document and an Internet-based location specification component that works in conjunction with the Internet browser. The Internet-based location specification component facilitates the viewing of the document when retrieved via the Internet browser. The Internet-based location specification component also facilitates the selective specification of placement information for the plurality of information items within the document.

In a related embodiment, the Internet-based location specification component further comprises a drag-and-drop rectangular box drawing utility for drawing a rectangular box that specifies the coordinates of one of the plurality of information items. The drag-and-drop rectangular box drawing utility facilitates selective relocation of the rectangular box that specifies the coordinates of one of the plurality of information items.

In another scanner based embodiment where the scanner is employed for scanning a paper document, the Internet-based location specification component facilitates the creation of the document by the scanning of the paper document on the scanner. It also facilitates the selective specification of placement information for the plurality of information items within the document.

In an other document repository based environment, the information item placement system saves the document along with the specification of placement information for the plurality of information items in the document at the document repository as a template. In a related embodiment, the information item placement system facilitates the retrieval of the template, the population of the plurality of information items in the template creating a populated document and the storage of the populated document.

In a secure signature and date placement system used to insert a plurality of signatures and dates in a document, a method of specifying placement information comprises retrieving the document; navigating to the right page in the document; dragging and dropping a rectangular box on the right page; capturing the corresponding x- and y-coordinates of the rectangular box; specifying a content type for the location specified by the rectangular box as a signature or date; selectively associating a placeholder content for the rectangular box for display purposes; and saving the page number and the x- and y-coordinates as a placement information for one of the plurality of signatures and dates and associating the placement information with the one of the plurality of signatures and dates.

### DETAILED DESCRIPTION OF THE DIAGRAMS

FIG. 1 is a perspective diagram of an secure signature and date placement system (also called a document flow network) 105 that provides mechanisms for the specification of coordinates, for signatures and dates, on documents and for the subsequent placement of signatures and dates in the specified coordinates. The document flow network 105 comprises a creator's browser 109 used by a document creator to specify placement information, such as coordinates and page numbers, for the placement of signatures, dates, etc. on documents, a signer's browser 121 used by one or more signers to view and sign documents, and a a viewer's browser 107 used by a viewer to view the signed document. A signature repository and verification system 113 is used to capture, save or retrieve electronic image signatures, digital signatures, and digital certificate information.

The signature or date placement information is specified by a user using the creator's browser by means of a document viewing software that facilitates the specification of coordinates for signatures and dates. Such signature or date placement information is subsequently associated with the document itself and stored in a document database 117 accessible via a server 115. In one embodiment, the server 115 is a web server that makes the document database 117 accessible via the Internet, dial-up &/or other public/private network 119 to users using the viewer's browser 107, the creator's browser 109 or the signer's browser 121. The document viewing software is executed on the creator's browser 109 in order to specify one or more signature and date placement information. In one embodiment, all such signature and date placement information is typically stored along with the document itself in the document database 117. In another embodiment, all such signature and date placement information is associated with the document but stored external to the document itself at the document database 117.

The document database 117 is used to store and retrieve documents, document templates, etc. Specifically, it is used to store documents with their contents, associated signature and date placement information, the signatures and dates themselves, and document security related information such as message digests, etc. More specifically, the signature or date placement information includes coordinates, corresponding page information, such as page numbers, etc.

In one embodiment, the creator's browser 109, the signer's browser 121 and the viewer's browser 107 is the same machine. In another related embodiment, the server 115 and the signature repository and verification system 111 are also incorporated into this same machine.

The signature of signers is selectively compared to older versions previously acquired to determine deviations and detect fraud. The signer may be asked to sign again or provide extra documentation for authentication if necessary.

FIG. 2A is a block diagram of an exemplary document 205 that, while being made secure employing a user's public and private key combination, also has embedded electronic image signatures and associated dates along with information regarding the placement of such electronic image signatures and dates. Specifically, the document 205 comprises an original document content sections 211, an image signature and date coordinates section 209, an associated image signatures and dates sections 213, and a message digest section 215.

The original document content sections 211 comprises one or more sections of a document originally created using an editor such as Microsoft Word, or a scanned image of a paper document. In one embodiment, it is a string of bytes in a tiff image format, representing the scanned image of a paper document.

When a document is initially created by an user, only the original document content sections 211 is available. Later, using a Document Viewer tool, the user specifies locations for one or more signatures and dates, which are then saved in the image signature and date coordinates section 209. When another user, such as a user who signs the document using the signer's browser 121, signs the document, the electronic image signature of the user is retrieved from the signature repository and verification system 111 and inserted into the associated image signatures and dates sections 213, along with corresponding dates. In addition, a message digest 215 is computed by the signer's browser or the server 115 and inserted into the message digest section 215 of the document 207.

In one embodiment, the message digest is computed using the by the sinner's browser 121 using the original document content sections 211, the image signature and date coordinates section 209 and the associated image signatures and dates sections 213 and inserted into the document. In another embodiment, only a subset of the available sections of a document are employed to generate the message digest.

FIG. 2B is an exemplary document 250 in an extensible manipulation language (XML) format that comprises a documentdata element 253 for the specification of document content, signature content and message digest content, and a signaturelocations element 261 for specification of signatures and date placements. Specifically, the documentdata element comprises a signature element 257 for the specification of electronic image signatures, a pages element 263 for the incorporation of multiple pages of a document's original content, and a message digest element 259 where a computed message digest is stored. The signaturelocations element 261 comprises a collection of page elements 265, one page element for each page of the document that contains a signature 267 or date 269 elements. The signature 267 or date 269 elements each specify the X- and Y-coordinates for placement within the corresponding page of the document 250.

FIG. 3A is a schematic block diagram 305 depicting the process of capturing signature and date placement information on a given document that has been scanned in, using the creator's browser 109 or a document viewer software application. At a block 307, the processing starts and a subsequent block 309, a new document is scanned by an user. The scanned document may be an actual document to be sent to another user or it might be just a template.

At a next block 311, the user drags the mouse drawing a box on specific sections of the document thus specifying the location of the signature or date. The creator's browser 109 or a document viewer software application then keeps track of the coordinates of the box drawn by the user that indicates the location for the placement of a signature or a date.

At a next block 313, the coordinates for signatures and dates are captured and saved. At the next decision box 315, an attempt is made to determine if the document nest be saved as a template or if the document is to be sent to one or more recipients. If it is determined that the document is to be saved as a template, then at a next block 317, the document is saved as a template that can be accessed later by a user. Otherwise, at a next block 319, the recipient's of the document are identified and the document is forwarded to them. In both cases, the processing finally ends at a block 321.

FIG. 3B is a diagram with a screen shot 330 of an exemplary application wherein a new office document type 325 is defined and signature coordinates and date coordinates are subsequently specified using an Internet-based application. An office document type, once defined, is used as a template by the user to create other similar documents and manipulate their signature and dates during a document signing process.

FIG. 3C is a diagram with a screen shot of the exemplary Internet-based application 340 showing the process of capturing signature 342 and date coordinates 344 after scanning in a document template using a scanner. In one embodiment, a scan button 346 activates a scanner for input of a document attached to the creator's browser 109. The choice of a signature drop-down item 342 or a date drop-down item 344 is provided to make it possible to specify the coordinates of a signature or date, respectively.

FIG. 3D is a diagram with a screen shot of the exemplary application showing the process of specifying signature or date coordinates by dragging a box using a mouse on the image of a scanned document. When a box is drawn on the scanned document using a mouse, a place holder signature is displayed in the box in the case of signatures, to mark the location. Similarly marked date locations display a dummy date. The coordinates of the box are automatically noted. A new location for the marked signature or date is specified by merely redrawing the box at a different location. This feature makes it easy to relocate a signature or date within the page.

FIG. 4 is a schematic block diagram describing the process of specifying signature placement information by dragging a mouse on a document. At a block 407, the processing starts. At a next block 409, the user opens a document using a document viewer, the document viewer being accessible over the Internet via the creator's browser or accessible as an independent application. Then, at a block 411, the user, using a mouse, drags a rectangular box on specific locations of the screen where a signature needs to be placed, and the document viewer software records the corresponding placement location, usually in X and Y coordinates. Similarly, the user may choose to specify placement information for a date. One or more Signatures and/or dates may be specified on each page.

In one embodiment, the user also specifies the order in which the signature and dates are to be entered into the documents, thus specifying a workflow for the document. In another embodiment, the user also specifies the identification of actual users who may sign at designated places in the document, in the specified order. In yet another embodiment, the user also specifies the roles of users who are allowed to sign in designated locations in the document.

Then, at a next block 413, the user can selectively replace the locations of the signatures by redrawing them or by adjusting the coordinates. Subsequently, at a block 415, the document viewer retrieves coordinates associated with each signature and date box specified by the user and saves them, at a next block 417, along with the document. The document thus becomes a template that may be reused. The processing terminates at a end block 419.

FIG. 5 is a schematic block diagram showing the workflow associated with the signing of documents using electronic image signatures. At a block 507, the process starts, and at a next block 509, the user, using the creator's browser 109, selectively retrieves a document template that specifies coordinates for signatures and dates to create a new document. Optionally, he creates a new document and specifies coordinates for signatures and dates. Then, at a next block 511, the user creates a new document based on the selected template.

Subsequently, at a next block 513, the created document is sent to a signer for signing, over the Internet 119. The signer, using the signer's browser 121, receives the document, views the document using a document viewer, and then signs it. Then, at a next block 515, the user receives a signed document with the signer's electronic image signatures, appropriate dates, and a message digest of the document for perusal. The signer can view or print the document with all signatures and dates incorporated. Then, at a next block 517, the user can verify the signature of the signer, before processing terminates at a final block 519.

Although a system and method according to the present invention has been described in connection with the preferred embodiment, it is not intended to be limited to the specific form set forth herein, but on the contrary, it is intended to cover such alternatives, modifications, and equivalents, as can be reasonably included within the spirit and scope of the invention as defined by this disclosure and appended diagrams.

1. An information item placement system comprising:
a document;
a plurality of information items;
a location specification component; and the location specification component facilitating the selective specification of placement information for the plurality of information items within the document.

2. The information item placement system of claim 1 wherein the plurality of information items selectively comprises signatures, images, dates, images, text and/or logos.

3. The information item placement system of claim 2 wherein the selectively specified placement information for the plurality of information items within the document is saved as part of the document.

4. The secure information item placement system of claim 2 wherein the selectively specified placement information for the plurality of information items within the document is saved separately from the document.

5. The information item placement system of claim 1 wherein the location specification component is a document viewer software that displays the document and provides location specification means.

6. The information item placement system of claim 5 wherein the location Specification means comprises a drag-and-drop box drawing utility with optional box relocation features.

7. The information item placement system of claim 6 wherein the drag-and-drop box drawing utility captures the page number and the x- and y-coordinates of a rectangular box drawn within a page to specify the placement of one of the plurality of information items in the document.

8. The information item placement system of claim 7 wherein placement information for the one of the plurality of information items in the document is selectively replaced by redrawing the rectangular box to specify a new location of the one of the plurality of information items in the document.

9. The information item placement system of claim 1 wherein placement information for each of the plurality of information items is expressed in terms of a page number of an associated page where it occurs in the document and the x- and y-coordinates of its location within the associated page.

10. The information item placement system of claim I wherein the plurality of information items comprises one or more signatures and dates and wherein the document comprises:
a plurality of original document content sections;
an image signature and date coordinates section for saving the placement information of one or more signatures and dates;
an associated image signatures and dates sections for saving one or more signatures and dates; and
a message digest section that is used to store a message digest that is computed selectively employing the contents of one or more of the other sections of the document.

11. The information item placement system of claim 10 wherein the plurality of original document content sections comprises a plurality of sections of a document originally created using a document editor.

12. The information item placement system of claim 10 wherein the plurality of original document content sections comprises a plurality of scanned sections of a document.

13. The information item placement system of claim 10 further comprising:
the location specification means comprising a drag-and-drop box drawing utility with optional box relocation features;
the drag-and-drop box drawing utility facilitating the selective specification of placement information for the plurality of information items within the document;
the drag-and-drop box drawing utility wherein the drag-and-drop box drawing utility captures the page number and the x- and y-coordinates of a rectangular box drawn within a page to specify the placement of one of the plurality of information items in the document; and
the drag-and-drop box drawing utility wherein the placement information for each of the plurality of information items expressed in terms of a page number of an associated page where it occurs in the document and a pair of x- and y-coordinates corresponding to a rectangular box drawn on the associated page specifying its location within the associated page.

14. The information item placement system of claim 13 wherein placement information for each of the plurality of information items is selectively replaced by redrawing the rectangular box drawn on the associated page or by adjusting the value of the associated pair of x- and y-coordinates.

15. An information item placement system comprising:
a document;
a plurality of information items that is selectively placed in the document;
an Internet browser that is used to retrieve the document;
an Internet-based location specification component that works in conjunction with the Internet browser;
the Internet-based location specification component facilitating the viewing of the document when retrieved via the Internet browser; and
the Internet-based location specification component facilitating the selective specification of placement information for the plurality of information items within the document.

16. The information item placement system of claim 15 wherein the Internet-based location specification component further comprising:
a drag-and-drop rectangular box drawing utility for drawing a rectangular box that specifies the coordinates of one of the plurality of information items; and
the drag-and-drop rectangular box drawing utility facilitating selective relocation of the rectangular box that specifies the coordinates of one of the plurality of information items.

17. The information item placement system of claim 16 wherein the information item placement system further comprises:
a paper document;
a scanner for scanning the paper document;
the Internet-based location specification component facilitating the creation of the document by the scanning of the paper document on the scanner; and
the Internet-based location specification component facilitating the selective specification of placement information for the plurality of information items within the document.

18. The information item placement system of claim 15 wherein the information item placement system further comprising:
a document repository; and
the information item placement system saving the document along with the specification of placement information for the plurality of information items in the document at the document repository as a template.

19. The information item placement system of claim 18 wherein the information item placement system further comprising:
the information item placement system facilitating the retrieval of the template;
the information item placement system facilitating the population of the plurality of information items in the template creating a populated document; and
the information item placement system facilitating the storage of the populated document.

20. A method of specifying placement information in a secure signature and date placement system used to insert a plurality of signatures and dates in a document, the method of specifying placement information comprising:
retrieving the document;
navigating to the right page in the document;
dragging and dropping a rectangular box on the right page;
capturing the corresponding x- and y-coordinates of the rectangular box;
specifying a content type for the location specified by the rectangular box as a signature or date;
selectively associating a placeholder content for the rectangular box for display purposes;
saving the page number and the x- and y-coordinates as a placement information for one of the plurality of signatures and dates and associating the placement information with the one of the plurality of signatures and dates.
